(19) United States
(12) Patent Application Publication
(10) Pub. No.: US 2012/0274573 A1
(43) Pub. Date: Nov. 1, 2012

(54) KOREAN INPUT METHOD AND APPARATUS USING TOUCH SCREEN, AND PORTABLE TERMINAL INCLUDING KEY INPUT APPARATUS

(75) Inventor: Sung-Jae Hwang, Daejeon (KR)

(73) Assignee: SAMSUNG ELECTRONICS CO. LTD., Suwon-si, Gyeonggi-do (KR)

(21) Appl. No.: 13/520,526

(22) PCT Filed: Dec. 23, 2010
(86) PCT No.: PCT/KR2010/009257

§ 371 Date: Jul. 3, 2012

(30) Foreign Application Priority Data
Jan. 4, 2010 (KR) 10-2010-0000116
Jan. 4, 2010 (KR) 10-2010-0000141

(51) Int. Cl. G06F 3/02

(52) U.S. Cl. 345/171

(57) ABSTRACT

An apparatus and method for inputting Korean characters are provided. The method includes determining an initial consonant by making a first touch of a consonant input key displayed on a touch screen and determining a vowel by making a second touch while maintaining the first touch and making a dragging gesture continuing from the second touch. The method of inputting Korean characters provides a Korean input scheme that effectively uses a multi-touch feature capable of recognizing simultaneous touches on two or more points.

### PRIORITY

This application is a National Stage application under 35 U.S.C. §371 of an International application filed on Dec. 23, 2010 and assigned application No. PCT/KR2010/009257, and claims the benefit under 35 U.S.C. §365(b) of a Korean patent application filed in the Korean Industrial Property Office on Jan. 4, 2010 and assigned Serial No. 10-2010-0000116, and a Korean patent application filed in the Korean Industrial Property Office on Jan. 4, 2010 and assigned Serial No. 10-2010-0000141, the entire disclosure of each of which is hereby incorporated by reference.

### BACKGROUND OF THE INVENTION

1. Field of the Invention

The present invention relates to a method of inputting Korean characters and an apparatus using a touch screen, and a portable terminal including a Korean input apparatus. More particularly, the present invention relates to a method and apparatus of inputting Korean characters using a touch screen, and a portable terminal including the Korean input apparatus, by which the number of touches is innovatively reduced to facilitate input of Korean characters and a limited space of the touch screen can be effectively used.

2. Description of the Related Art

The present invention relates to an apparatus and method for inputting Korean characters using a touch screen, by which the number of character input keys disposed on a touch screen used in an electronic device, such as a cellular phone, a Portable Media Player (PMP), a Mobile Internet Device (MID), or the like, is minimized and input of Korean characters is simplified.

Recently, as electronic devices have been miniaturized and touch screens have become more popular, a new character input scheme capable of replacing conventional input keys is demanded.

More particularly, Koreans usually input and use Korean characters more frequently than letters of the English alphabet. Therefore, there is an urgent need for development of a compact character input apparatus provided with a keypad designed to facilitate input of Korean characters.

In this regard, Korean Patent Publication No. 10-1999-0065826 uses a phoneme combination scheme in which a character typing method can be learned easily, but a large number of typing strokes is required due to the composition of vowels.

Korean Patent Publication No. 10-1999-0052447 is based on a visual reinterpretation in which Korean characters have to be reconstructed by reconstruction of consonants and on that account, this system falls beyond a basic algorithm of Korean. Moreover, a large number of typing strokes is required for input of consonants and it is not easy to learn the character typing method.

Korean Patent Registration No. 159191 fails to reduce the number of typing strokes for input of consonants and makes it difficult for users to understand the order of writing for input of compound vowels. That is, according to the conventional Korean input methods, an excessively large number of typing strokes increases the possibility of erroneous input and require excessive time for character input.

Therefore, a need exists for an apparatus and method for using a touch screen, by which the number of character input keys disposed on the touch screen is reduced to simplify input of Korean characters.

### SUMMARY OF THE INVENTION

Aspects of the present invention are to address at least the above-mentioned problems and/or disadvantages and to provide at least the advantages described below. Accordingly, an aspect of the present invention is to provide a Korean input method using a touch screen, by which the number of character input keys disposed on a touch screen is remarkably reduced to simplify and speed up input of Korean characters.

Another aspect of the present invention is to provide a Korean input apparatus using a touch screen, which performs the Korean input method using the touch screen.

Yet another aspect of the present invention is to provide a mobile device to which the Korean input apparatus using the touch screen is applied.

In accordance with an aspect of the present invention, a method of inputting Korean characters is provided. The method includes determining an initial consonant by making a first touch of a consonant input key displayed on a touch screen, and determining a vowel by making a second touch while maintaining the first touch and making a dragging gesture continuing from the second touch.

In an exemplary implementation, a plurality of consonant input keys may be displayed on the touch screen, and the second touch and the dragging gesture continuing from the second touch may be made on an arbitrary point on the touch screen, except for a point of the first touch. The vowel may be changed according to a length of the dragging gesture, and when a length of the dragging gesture is less than a first length, a pure vowel may be determined such that the pure vowel is “ [symbol] ” when a direction of the dragging gesture is up, is “ [symbol] ” when the direction is down, is “ [symbol] ” when the direction is right, and is “ [symbol] ” when the direction is left. When a length of the dragging gesture is more than the first length and less than a second length, the pure vowel may be changed into a compound vowel or is added to a vowel “ [symbol] ”. When a length of the dragging gesture is more than the second length, the compound vowel may be added to the vowel “ [symbol] ” or the pure vowel is changed into a compound vowel. The Korean input method may further include inputting a consonant and a vowel displayed on the touch screen by releasing the first touch.

In accordance with another aspect of the present invention, a method of inputting Korean characters is provided. The method includes determining an initial consonant by making a first touch of a consonant input key displayed on a touch screen, and determining a vowel “ [symbol] ” or “ [symbol] ” by making a second touch while maintaining the first touch. The Korean input method may further include changing the vowel by making a dragging gesture continuing from the second touch. A plurality of consonant input keys may be displayed on the touch screen, and the second touch and the dragging gesture continuing from the second touch may be made on an arbitrary point on the touch screen, except for a point of the first touch.

When a length of the dragging gesture is less than a first length, a pure vowel may be determined such that the pure vowel is “ [symbol] ” when a direction of the dragging gesture is up, is “ [symbol] ” when the direction is down, is “ [symbol] ” when the direction is right, and is “ [symbol] ” when the direction is left. When a length of the dragging gesture is more than the first length and less than a second length, the pure vowel may be changed into a compound vowel or is added to a vowel “ [symbol] ”. When a length of the dragging gesture is more than the second length, the compound vowel may be added to the vowel “ [symbol] ” or the pure vowel may be changed into a compound vowel.

In accordance with yet another aspect of the present invention, an input apparatus for combining and completing a Korean character according to user touch input and dragging gesture with respect to a plurality of consonant input keys displayed on a touch screen is provided. The apparatus includes the touch screen for displaying the consonant input keys and for outputting an input result, a touch detector for detecting a touch on the touch screen, a character combining means for determining an initial consonant according to a first touch of a consonant input key, detected by the touch detector, and for determining a vowel to be combined with the initial consonant according to a second touch made while maintaining the first touch and a dragging gesture continuing from the second touch, and a controller for combining the determined initial consonant and vowel and for outputting the combination to the touch screen. The character combining means may change a vowel according to a length of the dragging gesture. When a length of the dragging gesture is less than a first length, a pure vowel may be determined such that the pure vowel is “ [symbol] ” when a direction of the dragging gesture is up, is “ [symbol] ” when the direction is down, is “ [symbol] ” when the direction is right, and is “ [symbol] ” when the direction is left. When a length of the dragging gesture is more than the first length and less than a second length, the pure vowel may be changed into a compound vowel or may be added to a vowel “ [symbol] ”. When a length of the dragging gesture is more than the second length, the compound vowel may be added to the vowel “ [symbol] ” or the pure vowel may be changed into a compound vowel.

In accordance with still another aspect of the present invention, a portable terminal including the Korean input apparatus is provided.

In accordance with another aspect of the present invention, an apparatus for combining and completing a Korean character according to user touch input and dragging gesture with respect to a plurality of consonant input keys displayed on a touch screen is provided. The apparatus includes the touch screen for displaying the consonant input keys and for outputting an input result, a touch detector for detecting a touch on the touch screen, a character combining means for determining an initial consonant according to a first touch of a consonant input key, detected by the touch detector, for determining a vowel “ [symbol] ” or “ [symbol] ” according to a second touch of a point of the touch screen, which is spaced apart from the consonant input key in a predetermined direction, while maintaining the first touch, and for changing the vowel according to a dragging gesture continuing from the second touch, and a controller for combining the determined initial consonant and vowel and for outputting the combination to the touch screen.

According to exemplary embodiments, the second touch and the dragging gesture continuing from the second touch may be made on an arbitrary point on the touch screen, except for a point of the first touch. When a length of the dragging gesture is less than a first length, a pure vowel may be determined such that the pure vowel is “ [symbol] ” when a direction of the dragging gesture is up, is “ [symbol] ” when the direction is down, is “ [symbol] ” when the direction is right, and is “ [symbol] ” when the direction is left.

In accordance with yet another aspect of the present invention, a portable terminal including the Korean input apparatus is provided.

According to exemplary embodiments of the present invention, a scheme for effectively inputting Korean characters using a multi-touch feature capable of recognizing simultaneous touches on two or more points is provided. Therefore, the number of character input keys disposed on a touch screen used in a mobile device can be minimized, and a Korean character can be determined by a minimum touch action, thereby simplifying a Korean character input action and reducing the time required for inputting a Korean character. Also, the simplified Korean character input action allows for a more effective use of a limited touch screen region.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1 through 4 are flowcharts of a Korean input method according to an exemplary embodiment of the present invention;

FIGS. 5a through 5e are diagrams for describing a Korean input method according to an exemplary embodiment of the present invention;

FIGS. 6a through 6d are diagrams for describing a Korean input method according to an exemplary embodiment of the present invention;

FIGS. 7a through 7c are diagrams for describing a Korean input method according to an exemplary embodiment of the present invention;

FIGS. 8a through 8f are diagrams for describing a Korean input method according to an exemplary embodiment of the present invention;

FIGS. 9a through 9c are diagrams for describing a Korean input method according to another exemplary embodiment of the present invention; and

FIG. 10 is a block diagram of a Korean input apparatus according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, exemplary embodiments of the present invention will be described with reference to the attached drawings. In the drawings, the same reference numerals are used throughout the different drawings to designate the same or similar components, and repeated description of the same components is omitted.

Throughout the specification, when it is stated that a specific part includes a specific component, it means that the specific part may further include another component rather than exclude another component, unless stated otherwise. In addition, terms such as “unit”, “module”, and “block” denote a unit that performs at least one function or operation, which may be realized by hardware, software, or a combination of hardware and software.

Exemplary embodiments of the present invention provide a multi-touch-based Korean input method and apparatus which selects and determines a vowel by inputting an initial consonant by a touch (e.g., a first touch) of a consonant input key, making a touch (e.g., a second touch) of a point on a touch screen while maintaining the initial touch of the consonant input key, and making a dragging gesture by a user.

In addition, exemplary embodiments of the present invention input an initial consonant by a touch (e.g., a first touch) of a consonant input key and display and determine a vowel to be combined with the consonant by making a touch (e.g., a second touch) of a point on a touch screen in a predetermined direction with respect to the consonant input key while maintaining the initial touch of the consonant input key. In exemplary embodiments of the present invention, the vowel is determined according to the direction with respect to the selected consonant input key and the number of touches (i.e., second touches).

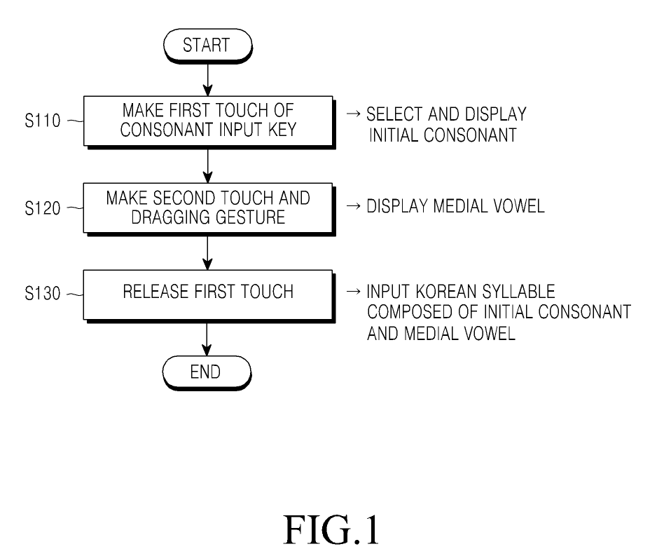

FIG. 1 is a flowchart of a Korean input method according to an exemplary embodiment of the present invention.

Referring to FIG. 1, the method of inputting a Korean character begins with a user's first touch of a consonant input key on a touch screen in step S110. Herein, an initial consonant of a Korean syllable is determined by the touched consonant input key. In exemplary embodiments of the present invention, the first touch is maintained and, in this state, consonant input keys other than the consonant input key whose touch is maintained are not activated. That is, as long as the touch is maintained, a consonant corresponding to another consonant input key is not input in spite of a touch input of the other consonant input key.

Thereafter, while the first touch of the consonant input key is maintained, the user makes a second touch of a point, which is spaced apart from the consonant input key in a predetermined direction, on the touch screen, and makes a so-called dragging gesture for moving an input means, such as a finger, in a predetermined direction while maintaining the second touch in step S120. In exemplary embodiments of the present invention, the second touch and the dragging gesture may be made at any point and region other than a point where the first touch is maintained, thus maximizing the use efficiency of a space of the touch screen. That is, although a plurality of consonant input keys are displayed on the touch screen, if the first touch of one of the consonant input keys is made and maintained, regions corresponding to the other consonant input keys are deactivated and a touch and a dragging gesture on those regions are interpreted as intending to determine a vowel.

After the vowel is displayed as a result of the second touch, the user releases the first touch, thereby inputting the initial consonant displayed on the touch screen and a medial vowel to be combined with the initial consonant as a basic unit of a Korean syllable in step S130.

In an exemplary embodiment of the present invention, a vowel is determined by a dragging gesture, and more specifically, a vowel is sequentially changed into “a pure vowel”, “a compound vowel”, and “stroke addition” according to a length of the dragging gesture.

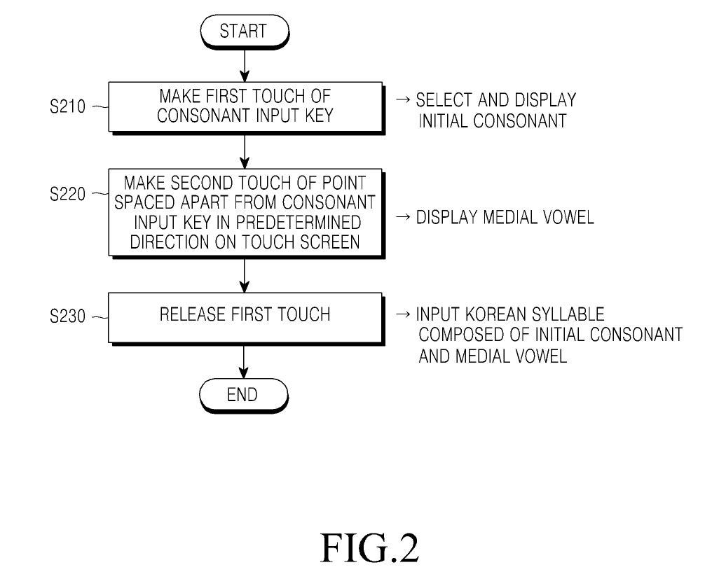

FIG. 2 is a flowchart of a Korean input method according to an exemplary embodiment the present invention.

Referring to FIG. 2, the Korean input method begins with step S210 in which a user makes a first touch of a consonant input key on a touch screen. Herein, an initial consonant of a Korean syllable is determined by the touched consonant input key. In exemplary embodiments of the present invention, the first touch is maintained and, in this state, consonant input keys other than the consonant input key whose touch is maintained are not activated. That is, as long as the touch is maintained, a consonant of another consonant input key is not input in spite of a touch input of the other consonant input key.

Thereafter, while the first touch of the consonant input key is maintained, the user makes a second touch of a point, which is spaced apart from the consonant input key in a predetermined direction, on the touch screen in step S220. That is, the initial consonant is displayed by the first touch and a vowel to be combined with the initial consonant is displayed by the second touch on the touch screen. More particularly, in exemplary embodiments of the present invention, the vowel to be combined with the initial consonant is determined by both the direction with respect to the initial consonant and the number of consecutive second touches.

After the vowel is displayed by the second touch, the user releases the first touch, thereby inputting the initial consonant displayed on the touch screen and the medial vowel to be combined with the initial consonant as a basic unit of the Korean syllable in step S230.

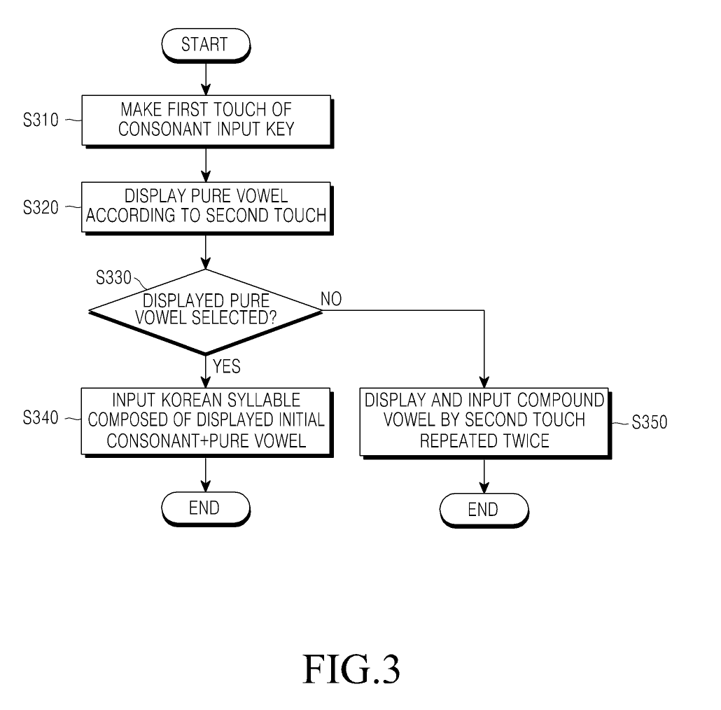

FIG. 3 is a flowchart of a Korean input method according to another exemplary embodiment of the present invention.

Referring to FIG. 3, while maintaining a first touch of a consonant input key corresponding to an initial consonant in step S310, the user makes a second touch of a point which is spaced apart from the consonant input key in a predetermined direction, on the touch screen, thus determining a pure vowel in step S320. In an exemplary embodiment of the present invention, the pure vowel, particularly the vowel direction of the pure vowel, is determined by the input direction of the second touch with respect to the consonant input key, such that “ [symbol] ” is selected as the pure vowel when the predetermined direction is to the right with respect to the touched consonant input key, “ [symbol] ” is selected when the predetermined direction is to the left with respect to the touched consonant input key, “ [symbol] ” is selected when the predetermined direction is up with respect to the touched consonant input key, and “ [symbol] ” is selected when the predetermined direction is down with respect to the touched consonant input key. Herein, the pure vowel means one of four basic vowels of “ [symbol] ”, “ [symbol] ”, “ [symbol] ”, and “ [symbol] ”, and a compound vowel means one of “ [symbol] ”, “ [symbol] ”, “ [symbol] ”, and “ [symbol] ” which are additions of arae-a or “lower a” to the basic vowels. Herein area-a or “lower a”, written as “•”, is an ancient vowel of Korean. For example, if area-a or “lower-a”, “•” is added (combined) to “ [symbol] ”, a vowel “ [symbol] ” can made made. In exemplary embodiments of the present invention, the direction of the second touch, which determines the pure vowel, has to be understood as an area having an angular range of a predetermined size, extending in the predetermined direction from the consonant input key, rather than an absolute direction which is determined from the consonant input key.

If the pure vowel is selected as the medial vowel of the Korean syllable, the Korean input process may be terminated in step S320. However, in exemplary embodiments of the present invention, considering input of a compound vowel, if the pure vowel is not selected in step S330, the second touch is repeated twice or more within a predetermined time to change the pure vowel displayed in step S320 into a compound vowel, thus combining the compound vowel with the initial consonant and displaying the Korean syllable composed of a combination of the vowel and consonant in step S350. If the second touch is made over the predetermined time, the second touch made second is a touch for determining the next Korean syllable rather than the medial vowel.

On the other hand, if the pure vowel displayed in step S320 is selected in step S330, once the Korean syllable composed of a combination of the desired initial consonant and medial vowel is displayed, the user may release the first touch, thus selecting the Korean syllable composed of the combination of the initial consonant and the medial vowel displayed on the touch screen in step S340. Thereafter, a final vowel may be additionally input. Herein, the release of a touch means removing a finger or a stylus pen from the touch screen such that a touch input is no longer made.

Exemplary embodiments of present invention also provide a new Korean input method which determines a vowel by a second touch spaced apart from a consonant input key corresponding to an initial consonant in a predetermined direction while maintaining a first touch of the consonant input key, but determines a pure vowel or a compound vowel by a single touch or double touch made substantially at the same time.

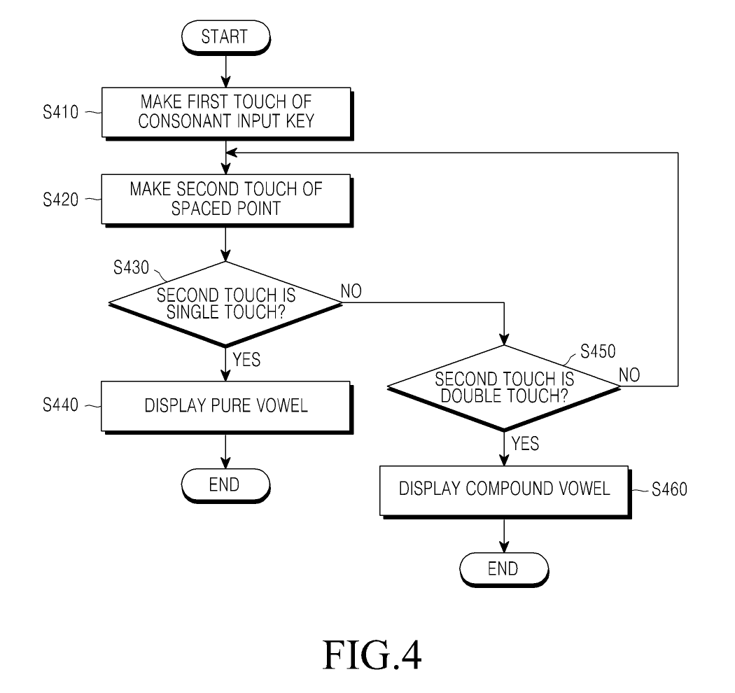

FIG. 4 is a flowchart of a Korean input method according to an exemplary embodiment of the present invention.

Referring to FIG. 4, after a first touch of a consonant input key corresponding to an initial consonant is made in step S410, a second touch of a point (or points), which is spaced apart from the consonant input key in a predetermined direction, on the touch screen is made while maintaining the first touch in step S420. The vowel direction is determined by the input direction of the second touch as described above, but in step S430, it is determined whether the second touch is a single touch which touches a single point substantially at the same time. If the second touch is a single touch, a pure vowel is determined and is displayed as being combined with the initial consonant in step S440. On the other hand, if the second touch is a multi-touch which touches two or more points substantially at the same time, especially, a double touch which simultaneously touches two points in step 450, the compound vowel is displayed as being combined with the initial consonant in step S460.

Thereafter, the first touch is released, thus inputting the Korean syllable selected and displayed in the preceding step.

Hereinafter, a Korean input method according to an exemplary embodiment of the present invention will be illustrated with reference to the accompanying drawings.

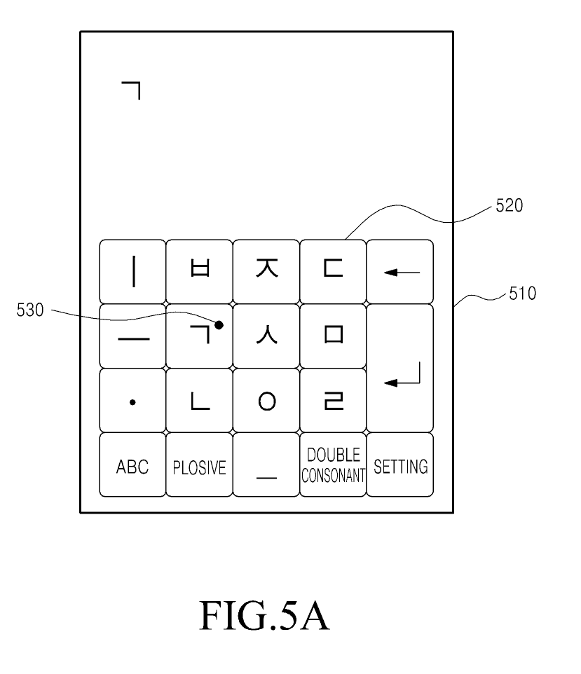

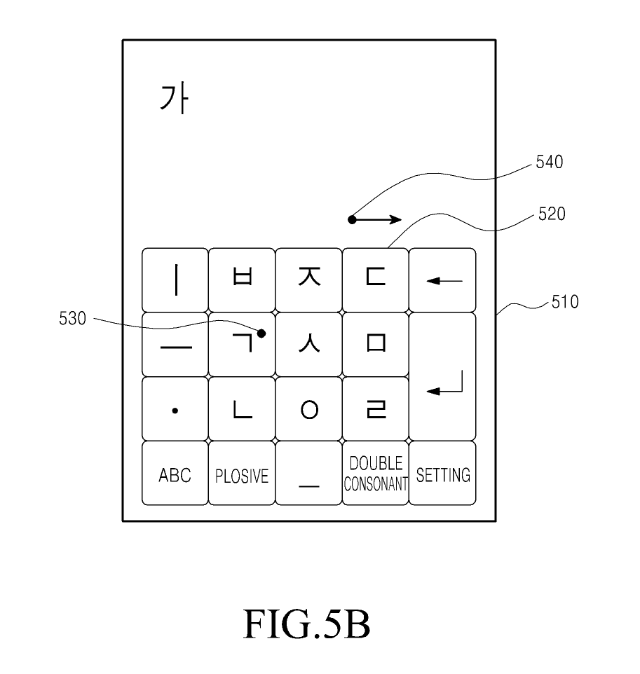

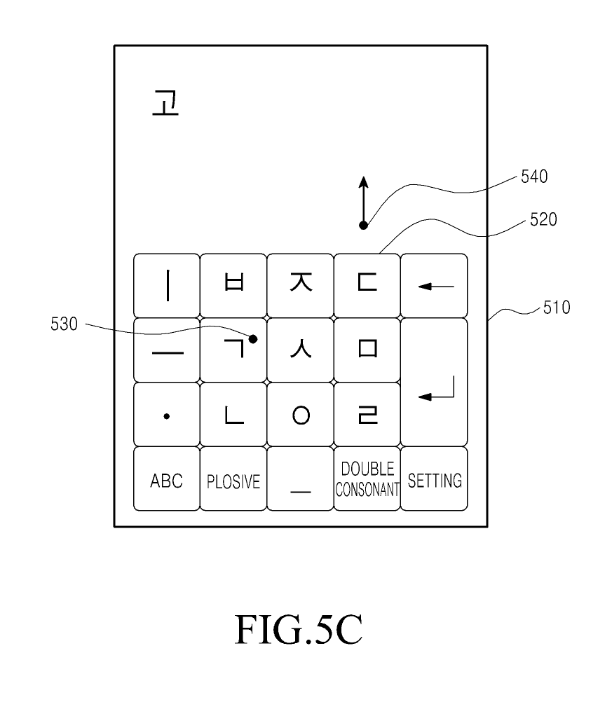

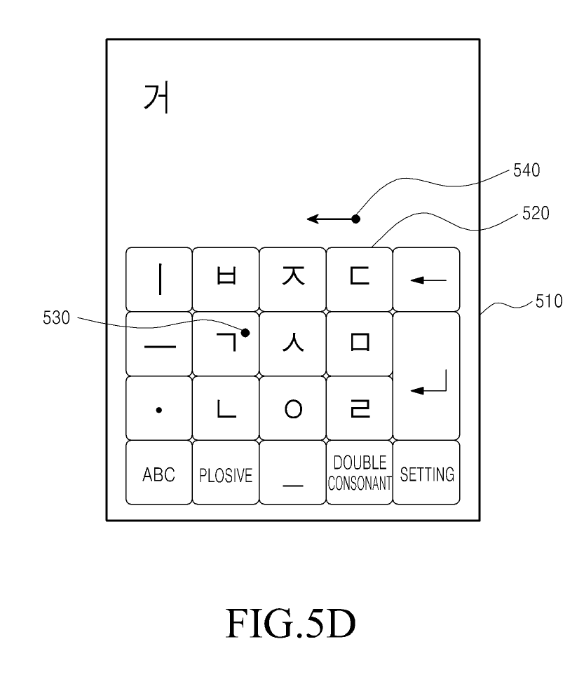

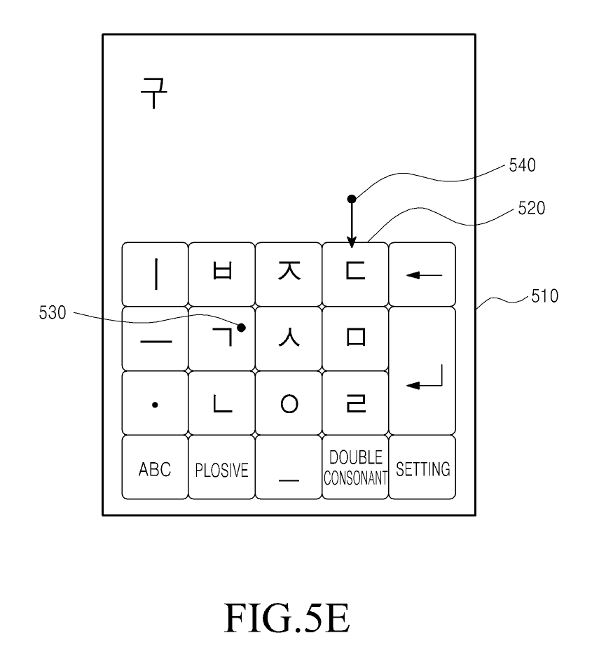

FIGS. 5a through 5e are diagrams for describing a Korean input method according to an exemplary embodiment of the present invention.

Referring to FIG. 5a, the user makes a first touch 530 on one of a plurality of consonant input keys 520 disposed on a touch screen 510, and maintains the first touch 530. By the first touch 530, an initial consonant of a Korean syllable is determined. In FIG. 5a, the first touch 530 of a consonant input key corresponding to a consonant “ [symbol] ” is made and thus the consonant “ [symbol] ” is input as displayed in the upper left-hand corner of the touch screen 510.

Referring to FIG. 5b, a second touch 540 on an arbitrary point of the touch screen 510 and a dragging gesture from the point of the second touch 540 are made as indicated by an arrow. A vowel is determined according to a direction and a length of the dragging gesture. If the length of the dragging gesture is less than a first length, a pure vowel such as “ [symbol] ”, “ [symbol] ”, “ [symbol] ”, or “ [symbol] ” is determined. More particularly, the determined vowel serves as a base vowel of a compound vowel such as “ [symbol] ”, “ [symbol] ”, “ [symbol] ”, or “ [symbol] ”. In an exemplary embodiment of the present invention, a vowel “ [symbol] ” is determined when the direction of the dragging gesture is up, a vowel “ [symbol] ” is determined when the direction of the dragging gesture is down, a vowel “ [symbol] ” is determined when the direction of the dragging gesture is right, and a vowel “ [symbol] ” is determined when the direction of the dragging gesture is left, such that the determined vowel is combined with the consonant determined by the first touch. Herein, the first length may be set freely by the user.

As illustrated in the upper left-hand corner of the touch screen 510, a Korean syllable “ [symbol] ” is input by the dragging gesture directed to the right in FIG. 5b. Similarly, Korean syllables “ [symbol] ”, “ [symbol] ”, and “ [symbol] ” are input by dragging gestures directed up, to the left, and down as illustrated in FIGS. 5c, 5d, and 5e, respectively.

Another exemplary embodiment of the present invention provides a Korean input method for inputting a compound vowel or a complex vowel which is a combination of a pure vowel and “ [symbol] ” by a dragging gesture whose length is greater than a length (e.g., a first length) for inputting the pure vowel, in addition to inputting a pure vowel by a dragging gesture of a relatively short length.

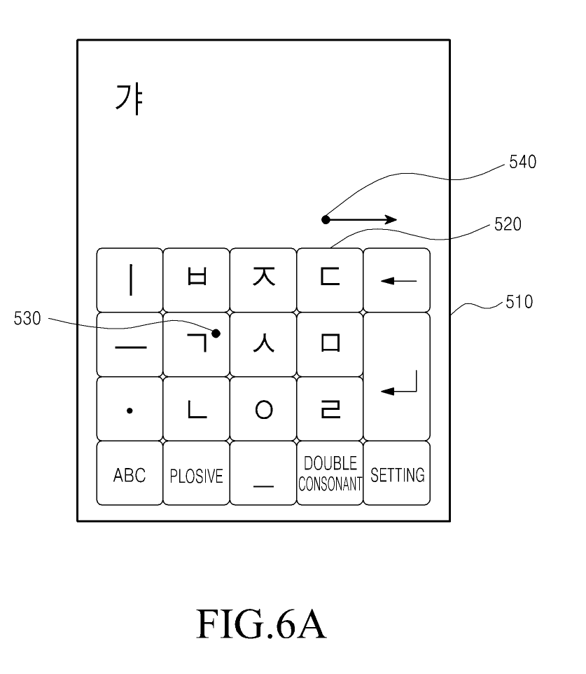

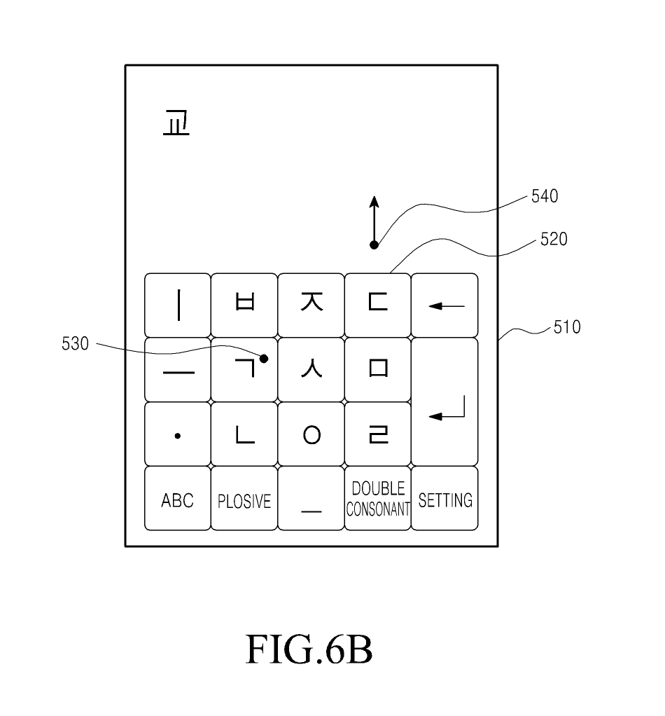

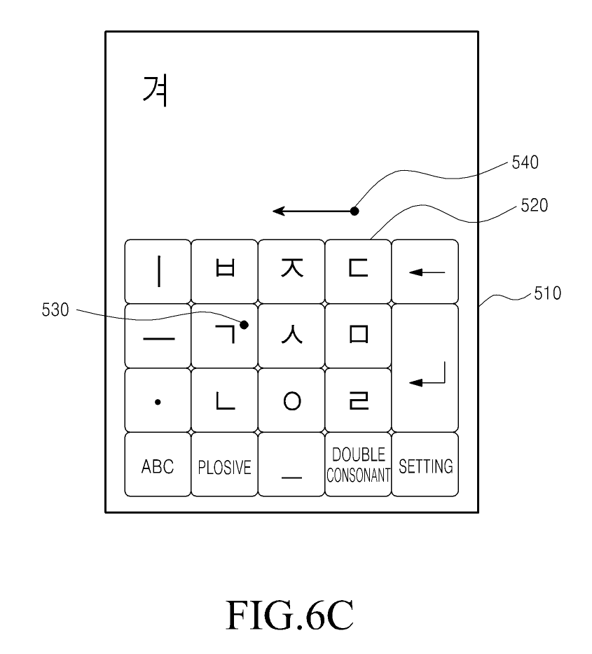

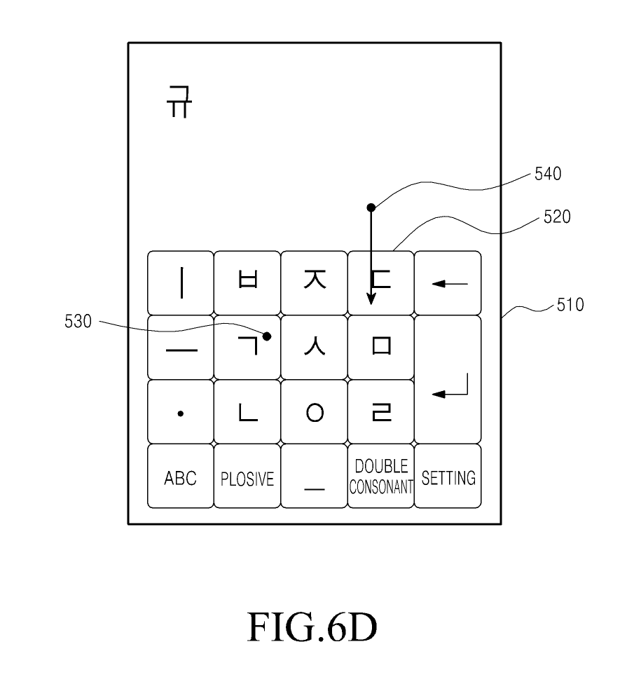

FIG. 6a shows an example where, after the Korean syllable “ [symbol] ” is input as shown in FIG. 5a, the dragging gesture is lengthened to more than a second length, such that the pure vowel “ [symbol] ” is changed into a compound vowel “ [symbol] ” and thus a Korean syllable “ [symbol] ” is input. Since the second touch and the dragging gesture may be made in any region of the touch screen except for a point where the input of the initial consonant is maintained (e.g., where the first touch is maintained) in exemplary embodiments of the present invention, the touch screen size restriction may be addressed. In addition, the vowel “ [symbol] ” may be added to a pure vowel, such as a complex vowel “ [symbol] ”, instead of the compound vowel “ [symbol] ”, by the extension of the dragging gesture's length, which also falls within the scope of the exemplary embodiments of present invention.

FIGS. 6b through 6d show input results after making the second touch and extending the dragging gesture's length, from which it can be seen that compound vowels “ [symbol] ”, “ [symbol] ”, and “ [symbol] ” are input. Instead of the compound vowel “ [symbol] ”, a complex vowel “ [symbol] ” which is a combination of the pure vowel “ [symbol] ” and the vowel “ [symbol] ” may be input, which also falls within the scope of exemplary embodiments of the present invention.

Also in exemplary embodiments of the present invention, when the dragging gesture's length is extended beyond a length condition for inputting a compound vowel (e.g., more than the first length and less than the second length), the vowel “ [symbol] ” may be added or a compound vowel may be determined. If the vowel “ [symbol] ” is added, a vowel to which the vowel “ [symbol] ” is to be added may be a pure vowel or a compound vowel, which may be set freely. For example, if the vowel “ [symbol] ” is added to a pure vowel (“ [symbol] ”), the vowel “ [symbol] ” may be determined. Similarly, if the vowel “ [symbol] ” is added to a compound vowel (“ [symbol] ”), the vowel “ [symbol] ” may be determined.

In exemplary embodiments of the present invention, the order of pure vowel-compound vowel-“ [symbol] ” addition according to the length of the dragging gesture may be changed freely, and for example, the order may be pure vowel-“ [symbol] ” addition-compound vowel. Once a Korean syllable which is a combination of a desired consonant and a desired vowel is displayed on the touch screen, the first touch maintained for the consonant is released as in step S130 of FIG. 1, thus inputting the Korean syllable displayed on the touch screen.

Another exemplary embodiment of the present invention provides a method for inputting the vowel “ [symbol] ” or “ [symbol] ” according to a direction of a point on which the second touch is made (e.g., a direction with respect to a consonant input key on which the first touch is made), as well as a direction of a dragging gesture. This method is the same as the foregoing Korean input method, but the vowel “ [symbol] ” or “ [symbol] ” is determined in case of the second touch without a dragging gesture. In an exemplary embodiment of the present invention, the vowel “ [symbol] ” or “ [symbol] ” is determined according to a direction of the second touch point, as will be described below with reference to the drawings.

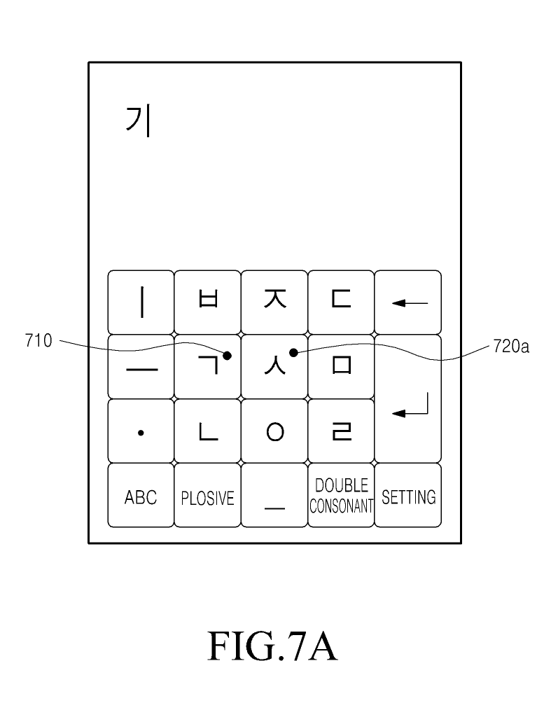

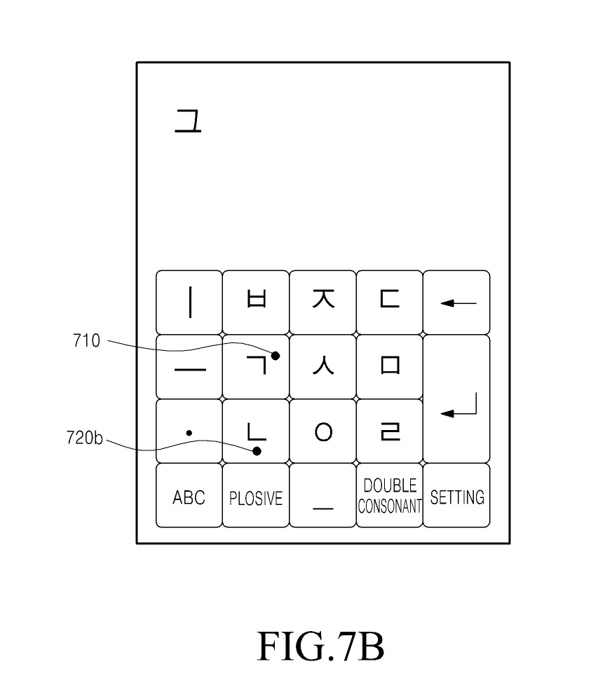

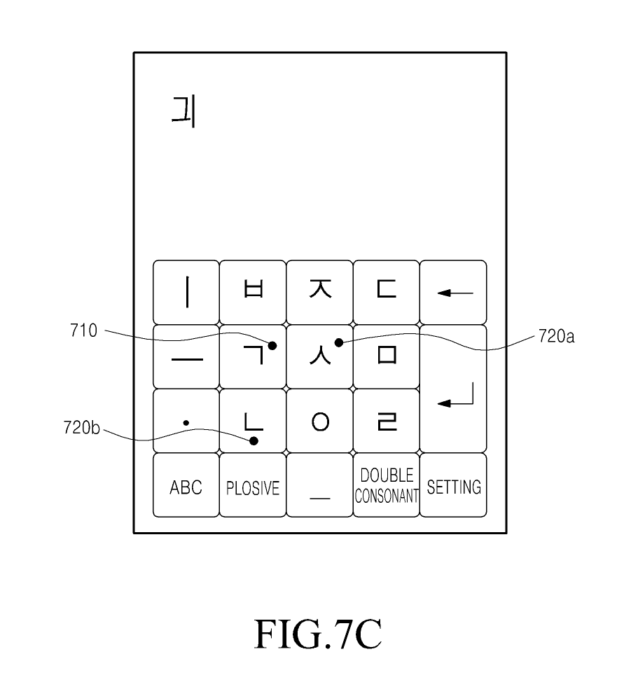

FIGS. 7a through 7c are diagrams for describing a Korean input method according to an exemplary embodiment of the present invention.

Referring to FIG. 7a, a second touch is made on a point 720a of a touch screen, which is directed horizontally (e.g., to the right) with respect to a consonant input key 710 on which a first touch is made, from which it can be seen that a combination of the vowel “ [symbol] ” and a consonant determined as an initial consonant is input. The horizontal direction does not necessarily mean a parallel line and may be a region having a predetermined angle and size with respect to the first touch point. Therefore, the vowel “ [symbol] ” may also be determined by the second touch made on a left region as well as the right region.

Referring to FIG. 7b, a second touch is made on a point 720b which is directed vertically with respect to the consonant input key 710, such that the vowel “ [symbol] ” is input.

Referring to FIG. 7c, the two points 720a and 720c, directed horizontally and vertically, are simultaneously or sequentially input, such that the vowel “ [symbol] ” and the vowel “ [symbol] ” are combined and input.

Thereafter, the input vowel is changed according to a length of a dragging gesture, as already described with reference to FIGS. 6a through 6d. In other words, a vowel is changed into pure vowel-compound vowel-“ [symbol] ” addition or pure vowel-“ [symbol] ” addition or compound vowel as a length of a dragging gesture is extended. By releasing the first touch, the user finishes inputting a Korean syllable composed of an initial consonant and a medial vowel, after which the user may add a final consonant to the input Korean syllable by making a separate touch of a consonant input key.

Exemplary embodiments of present invention also provide a Korean input apparatus for realizing the Korean input method on the touch screen.

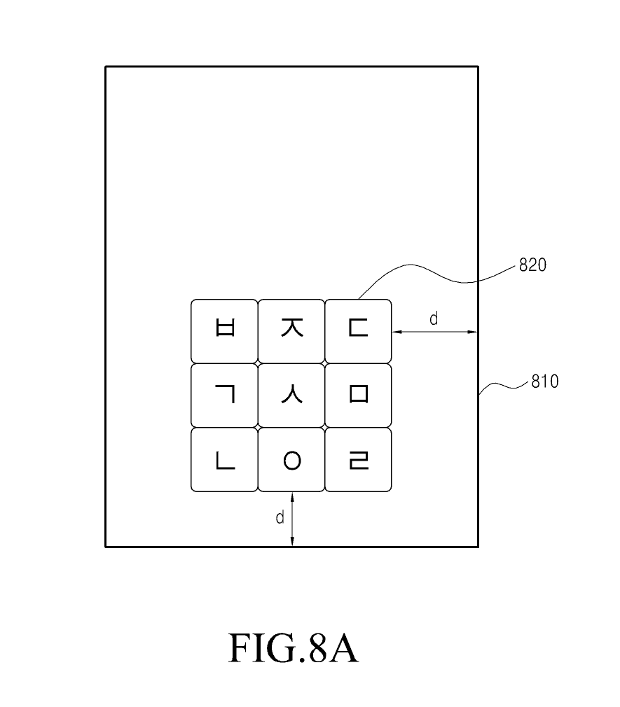

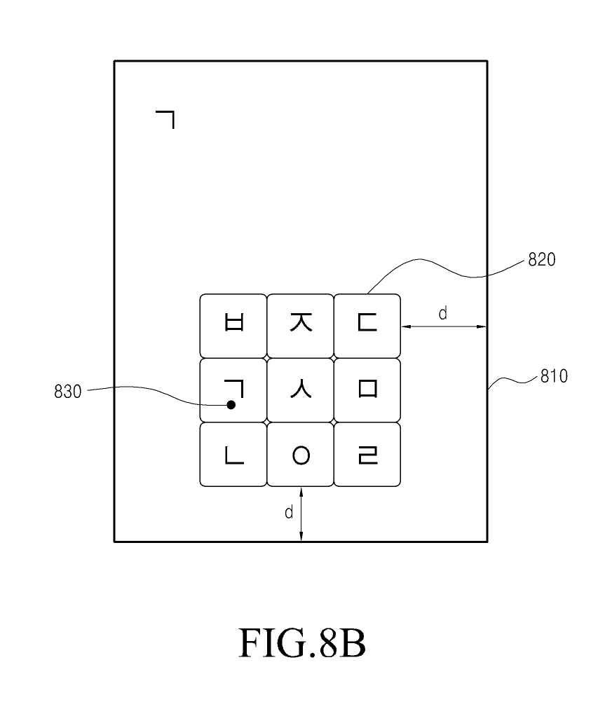

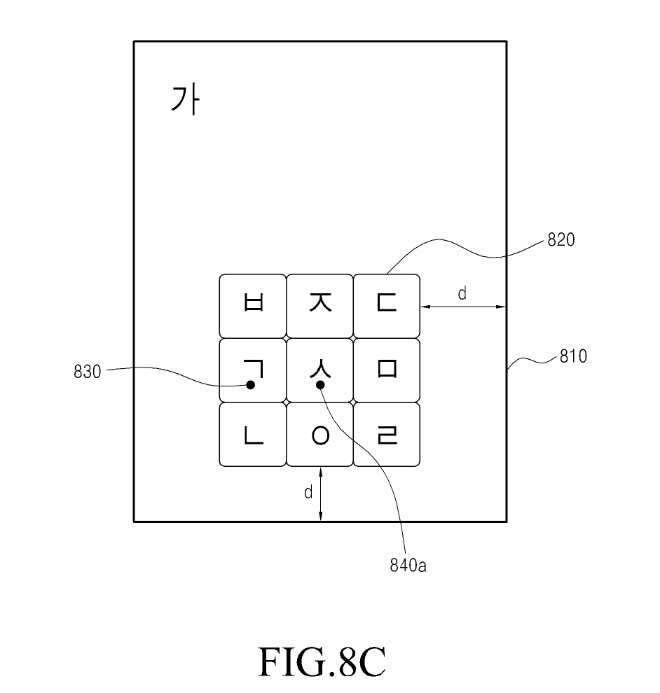

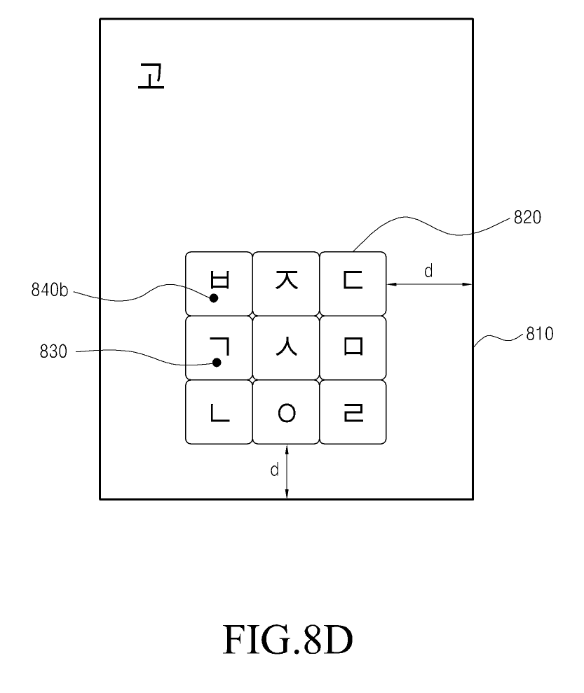

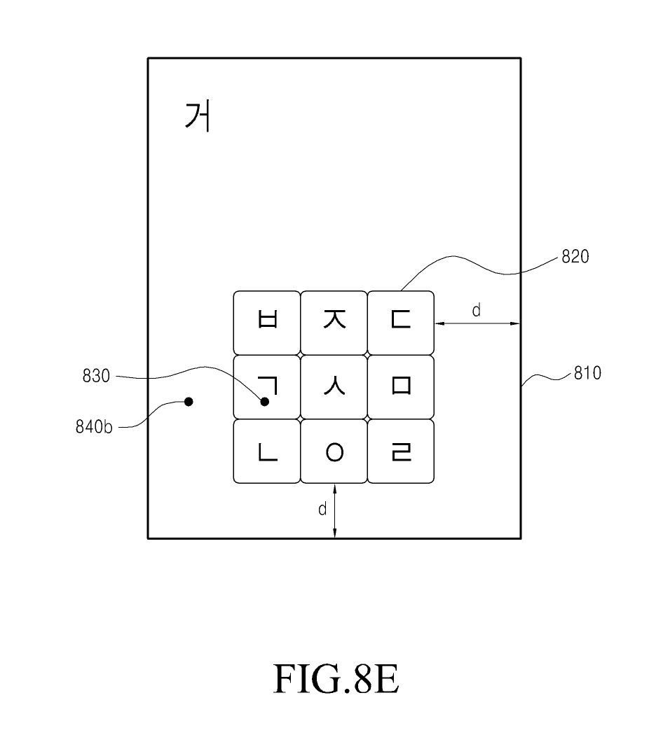

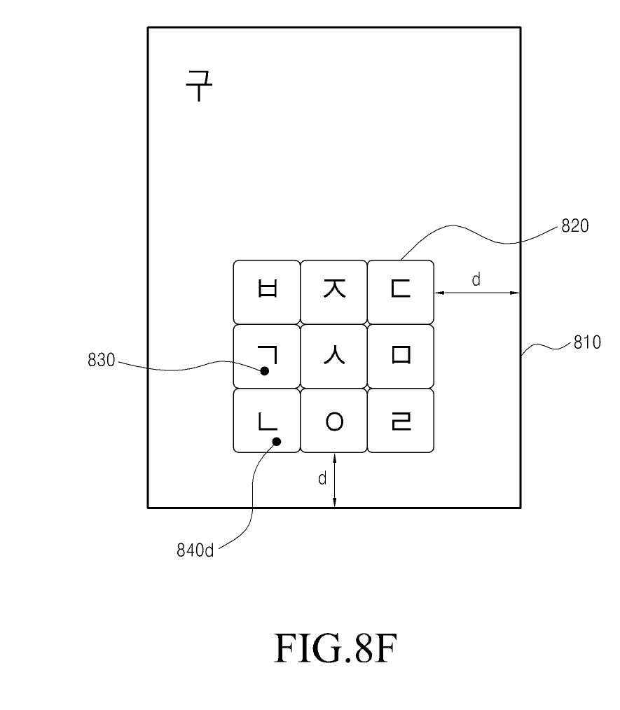

FIGS. 8a through 8f are diagrams for describing a Korean input method according to an exemplary embodiment of the present invention.

Referring to FIG. 8a, a plurality of consonant input keys 820 are displayed on an input window of a touch screen 810. In particular, a distance d between the consonant input keys 820 and the touch screen 810 may provide a space which allows a user to touch the touch screen 810 for determining a vowel.

Referring to FIG. 8b, the user makes a first touch 830 on any one of the plurality of consonant input keys 820, thus selecting an initial consonant and displaying the initial consonant on an output window of the touch screen 810.

Referring to FIG. 8c, the user makes a second touch 840a on a point in a right direction with respect to the consonant “ [symbol] ” while maintaining the first touch 830 on the consonant input key.

The vowel “ [symbol] ” is selected by the second touch made in the right direction, and is combined with the consonant selected by the first touch, such that a (partially) completed Korean syllable “ [symbol] ” is displayed on the output window.

FIGS. 8d through 8f are diagrams showing Korean input results when the second touch is made in the up direction, the down direction, and the left direction, respectively.

Referring to FIGS. 8d through 8f, it can be seen that the pure vowel, especially the vowel direction of the pure vowel, is determined by a direction of the second-touch point (840b, 840c, or 840d) with respect to the first-touch 830 on the consonant input key.

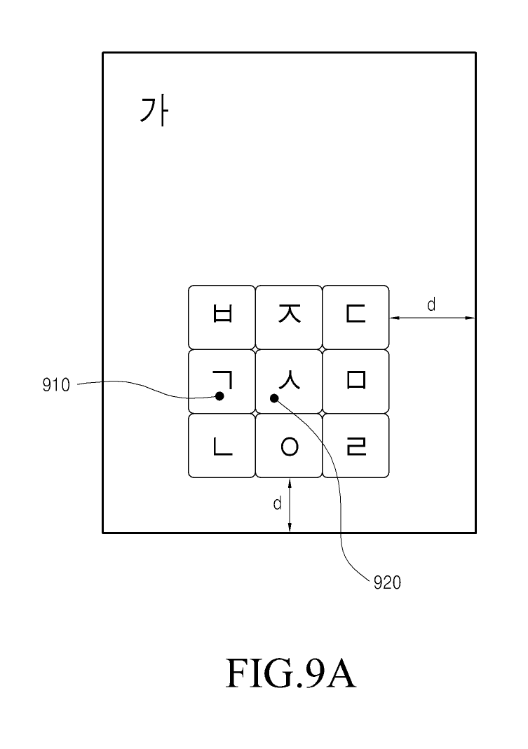

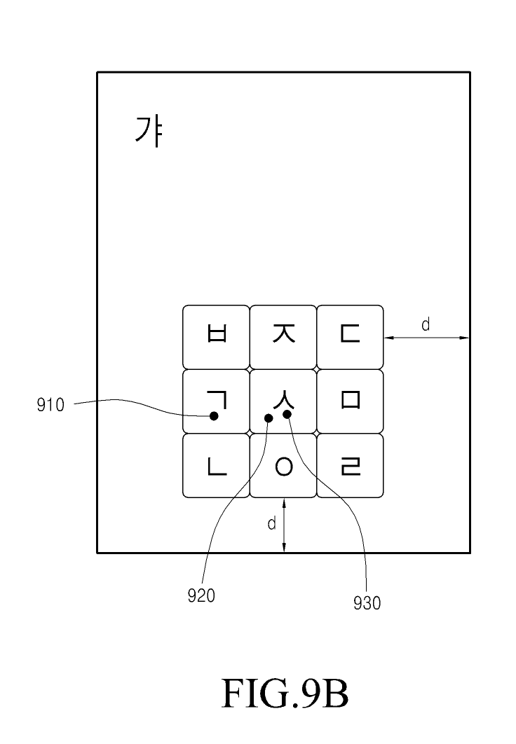

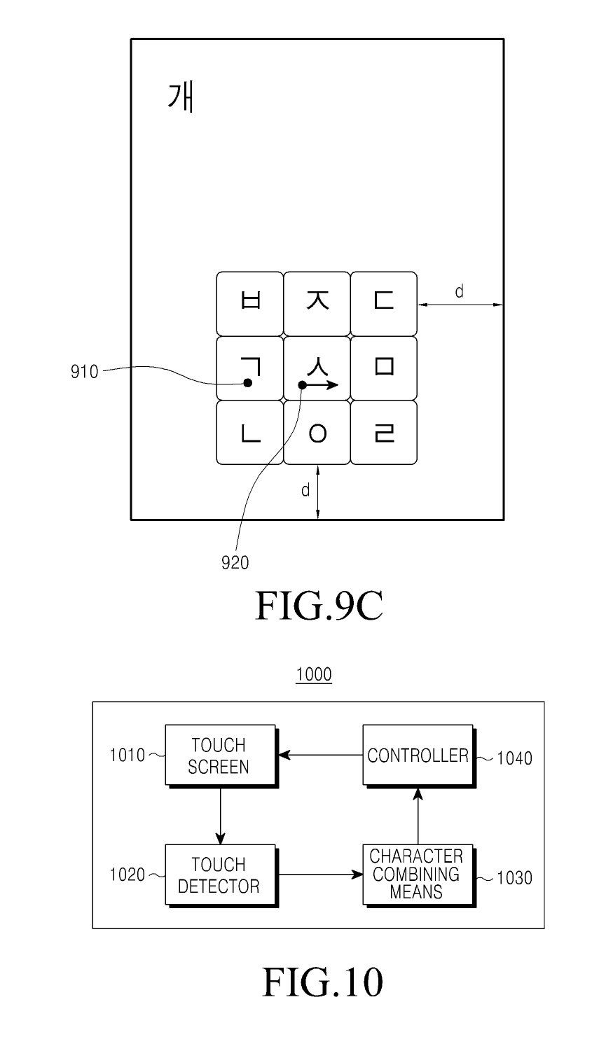

FIGS. 9a through 9c are diagrams for describing a Korean input method according to another exemplary embodiment of the present invention.

Referring to FIG. 9a, after making a first touch 910 of any one of a plurality of consonant input keys, the user makes a second touch 920 in the right direction, thus completing a Korean syllable.

However, in FIG. 9a, the second touch 920 is a touch of a single point in the right direction with respect to the consonant input key, and thus a pure vowel is displayed and combined with the initial consonant, as illustrated in the upper left-hand corner. In FIG. 9b, unlike in FIG. 9A, two arbitrary points 920 and 930 in the right direction are touched substantially at the same time and thus a compound vowel is displayed and combined with the initial consonant. That is, in another exemplary embodiment of the present invention, the pure vowel or the compound vowel is determined by the number of touches made substantially at the same time (e.g., made consecutively in FIG. 8). In this way, a time for a Korean input process can be reduced. FIG. 9c is a diagram showing an input result when a dragging gesture is made by a predetermined distance after the second touch 920 in FIG. 9a or FIG. 9b.

Referring to FIG. 9c, another stroke is added by dragging where the added stroke is a vowel “ [symbol] ” added to a pure vowel or a compound vowel and thus “ [symbol] ” is changed to “ [symbol] ” and “ [symbol] ” is changed to “ [symbol] ”. In this way, according to an exemplary embodiment of the present invention, the vowel “ [symbol] ” is added by the dragging gesture. This feature can also be applied to the exemplary embodiment shown in FIGS. 8a through 8c and falls within the scope of exemplary embodiments of the present invention. A distance ‘d’ between the input window on which consonant input keys are displayed and the touch screen has technical significance as a space which allows such dragging.

FIG. 10 is a block diagram of a Korean input apparatus 1000 according to an exemplary embodiment of the present invention.

Referring to FIG. 10, the Korean input apparatus 1000 combines and completes a Korean character according to a user's touch input and dragging gesture with respect to consonant input keys on a touch screen 1010, and includes the touch screen 1010 on which the consonant input keys are displayed and an input result is output. The touch screen 1010 may be of any type such as a resistive type or a capacitive type. The Korean input apparatus 1000 also includes a touch detector 1020 for detecting a touch on the touch screen 1010. The touch detector 1020 includes not only a sensor included in the touch screen 1010 but also a series of processes for determining coordinates of a touch by using a detected electric signal.

The Korean input apparatus 1000 also includes a character combining means 1030 which may be implemented as an operator or a central processing device for determining an initial consonant according to a first touch of a consonant input key and determining a vowel to be combined with the initial consonant according to a second touch and a dragging gesture with respect to a particular point of the touch screen 1010, which is spaced apart from the consonant input key in a predetermined direction, while maintaining the first touch. The Korean input apparatus 1000 further includes a controller 1040 for outputting the combined Korean syllable onto the touch screen 1010.

In an exemplary embodiment of the present invention, the character combining means 1030 changes the vowel according to a length of the dragging gesture, thus displaying a pure vowel-a compound vowel-a complex vowel which has added thereto the vowel “ [symbol] ”, such that when the desired vowel is displayed, the user releases the first touch, thus inputting a Korean syllable displayed on the touch screen 1010.

In an exemplary embodiment of the present invention, when the length of the dragging gesture is less than a first length, a pure vowel is determined. For example, the vowel “ [symbol] ” is determined when the direction of the dragging gesture is up, the vowel “ [symbol] ” is determined when the direction of the dragging gesture is down, the vowel “ [symbol] ” is determined when the direction of the dragging gesture is right, and the vowel “ [symbol] ” is determined when the direction of the dragging gesture is left. The example and order of vowels changed according to a range of the length of the dragging gesture have already been described above and thus will not be described at this time.

According to another exemplary embodiment of the present invention, the character combining means 1030 inputs the vowel “ [symbol] ” or “ [symbol] ” according to a position of the second touch. In an exemplary embodiment of the present invention, if the second touch is made on a region directed horizontally with respect to the consonant input key on which the first touch is made, the vowel “ [symbol] ” is input. If the second touch is made on a region directed vertically with respect to the consonant input key on which the first touch is made, the vowel “ [symbol] ” is input. The input vowel is also changed according to the subsequent dragging gesture as described previously.

The character combining means 1030 also determines the initial consonant by the first touch of the consonant input key, and determines a vowel to be combined with the initial consonant by the second touch of a point spaced apart from the consonant input key in a predetermined direction on the touch screen while maintaining the first touch. That is, the character combining means 1030 determines a direction of a pure vowel according to the predetermined direction, such that “ [symbol] ” is selected if the direction is right, “ [symbol] ” is selected if the direction is left, “ [symbol] ” is selected if the direction is up, and “ [symbol] ” is selected if the direction is down. If the second touch is repeated twice within a predetermined time, the pure vowel is changed into a compound vowel as already described with reference to FIGS. 8a-8f. Thereafter, the vowel “ [symbol] ” may be added by dragging.

The character combining means 1030 determines a pure vowel or a compound vowel according to whether a point or two points spaced apart from the consonant input key in the predetermined direction is or are touched. In other words, when the predetermined direction is the right direction with respect to the consonant input key touched for the initial consonant, the vowel “ [symbol] ” or “ [symbol] ” is determined, such that the pure vowel “ [symbol] ” is selected for a single touch and the compound vowel “ [symbol] ” is selected for a double touch. Likewise, the vowel “ [symbol] ” is selected when the predetermined direction is the left direction, the vowel “ [symbol] ” is selected for the predetermined direction of up, and the vowel “ [symbol] ” is selected for the predetermined direction of down. In this way, in an exemplary embodiment of the present invention, the pure vowel or the compound vowel is determined according to the single touch or the double touch. Moreover, the vowel “ [symbol] ” may also be added by a dragging continuing from the second touch, as described above.

Moreover, according to another exemplary embodiment of the present invention, after making the first touch of the consonant input key, the user makes the second touch of another point on the touch screen while maintaining the first state, thereby changing the consonant into a plosive or a double consonant.

For example, when a first touch of a consonant “ [symbol] ” is made, a touch (e.g., second touch) of another point is made, thus changing the consonant “ [symbol] ” into a plosive “ [symbol] ”. Thereafter, a vowel to be combined with the consonant may be determined by a dragging gesture. For example, if the dragging gesture is made in the right direction with respect to the consonant input key, the vowel “ [symbol] ” is determined, the vowel “ [symbol] ” is determined for the dragging gesture made in the left direction, the vowel “ [symbol] ” is determined for the dragging gesture made in the up direction, and the vowel “ [symbol] ” is determined for the dragging gesture made in the down direction. In addition, when the second touch is repeated twice, the plosive is changed into a double consonant, such that “ [symbol] ” may be displayed. In this way, when a multi-touch is made after selection of the desired consonant input key, the consonant as well as the vowel can be input in various forms and this feature falls within the scope of exemplary embodiments of the present invention.

The Korean input apparatus and method according to exemplary embodiments of the present invention can be applied to any touch screen-based electronic device such as a portable terminal, a PMP, a notebook, and so forth.

According to exemplary embodiments of the present invention, a Korean input scheme effectively using a multi-touch feature capable of recognizing simultaneous touches on two or more points is provided. Therefore, the number of character input keys disposed on a touch screen used in a mobile device can be minimized, and a Korean character can be combined by a minimum touch action, thereby simplifying a Korean character input action, reducing the time required for inputting a Korean character, and more effectively using a limited touch screen region.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method of inputting Korean characters, the method comprising:
determining an initial consonant by making a first touch of a consonant input key displayed on a touch screen; and
determining a vowel by making a second touch while maintaining the first touch and making a dragging gesture continuing from the second touch.

2. The method of claim 1, wherein a plurality of consonant input keys are displayed on the touch screen.

3. The method of claim 1, wherein the vowel is changed according to a length of the dragging gesture.

4. A method of inputting Korean characters, the method comprising:
determining an initial consonant by making a first touch of a consonant input key displayed on a touch screen; and
determining a vowel “ [symbol] ” or “ [symbol] ” by making a second touch while maintaining the first touch.

5. The method of claim 4, further comprising changing the vowel by making a dragging gesture continuing from the second touch.

6. The method of claim 54, wherein the second touch and the dragging gesture continuing from the second touch are made on an arbitrary point on the touch screen, except for a point of the first touch.

7. An apparatus for combining and completing a Korean character according to user touch input and dragging gesture with respect to a plurality of consonant input keys displayed on a touch screen, the apparatus comprising:
the touch screen for displaying the consonant input keys and for outputting an input result;
a touch detector for detecting a touch on the touch screen;
a character combining means for determining an initial consonant according to a first touch of a consonant input key, detected by the touch detector, and for determining a vowel to be combined with the initial consonant according to a second touch made while maintaining the first touch and a dragging gesture continuing from the second touch; and
a controller for combining the determined initial consonant and vowel and for outputting the combination to the touch screen.

8. The apparatus of claim 7, wherein the character combining means changes a vowel according to a length of the dragging gesture.

9. An apparatus for combining and completing a Korean character according to user touch input and dragging gesture with respect to a plurality of consonant input keys displayed on a touch screen, the apparatus comprising:
the touch screen for displaying the consonant input keys and for outputting an input result;
a touch detector for detecting a touch on the touch screen;
a character combining means for determining an initial consonant according to a first touch of a consonant input key, detected by the touch detector, for determining a vowel “ [symbol] ” or “ [symbol] ” according to a second touch of a point of the touch screen, which is spaced apart from the consonant input key in a predetermined direction, while maintaining the first touch, and for changing the vowel according to a dragging gesture continuing from the second touch; and
a controller for combining the determined initial consonant and vowel and for outputting the combination to the touch screen.

10. The apparatus of claim 9, wherein the second touch and the dragging gesture continuing from the second touch are made on an arbitrary point on the touch screen, except for a point of the first touch.

11. The apparatus of claim 10, wherein when a length of the dragging gesture is less than a first length, a pure vowel is determined such that the pure vowel is “ [symbol] ” when a direction of the dragging gesture is up, is “ [symbol] ” when the direction is down, is “ [symbol] ” when the direction is right, and is “ [symbol] ” when the direction is left.

12. A method of inputting Korean characters, the method comprising:
displaying and determining an initial consonant by making a first touch of a consonant input key displayed on a touch screen; and
displaying and determining a vowel to be combined with the initial consonant by making a second touch of a point spaced apart from the consonant input key in a predetermined direction on the touch screen while maintaining the first touch.

13. The method of claim 12, wherein a vowel “ [symbol] ” is displayed when the predetermined direction is up with respect to the consonant input key;
a vowel “ [symbol] ” is displayed when the predetermined direction is down with respect to the consonant input key;
a vowel “ [symbol] ” is displayed when the predetermined direction is right with respect to the consonant input key; and
a vowel “ [symbol] ” is displayed when the predetermined direction is left with respect to the consonant input key.

14. An apparatus for combining and completing a Korean character according to user touch input and dragging gesture with respect to a plurality of consonant input keys displayed on a touch screen, the Korean input apparatus comprising:
the touch screen for displaying the consonant input keys and for outputting an input result;
a touch detector for detecting a touch on the touch screen;
a character combining means for determining an initial consonant according to a first touch of a consonant input key, detected by the touch detector, and for determining a vowel to be combined with the initial consonant by making a second touch of a point spaced apart from the consonant input key in a predetermined direction on the touch screen while maintaining the first touch; and
a controller for combining the determined initial consonant and vowel and for outputting the combination to the touch screen.

15. The apparatus of claim 14, wherein a vowel “ [symbol] ” is displayed when the predetermined direction is up with respect to the consonant input key;
a vowel “ [symbol] ” is displayed when the predetermined direction is down with respect to the consonant input key;
a vowel “ [symbol] ” is displayed when the predetermined direction is right with respect to the consonant input key; and
a vowel “ [symbol] ” is displayed when the predetermined direction is left with respect to the consonant input key.

16. The method of claim 3, wherein the vowel is sequentially changed to a pure vowel, a compound vowel, and stroke addition according to the length of the dragging gesture.

17. The apparatus of claim 8, wherein the vowel is sequentially changed to a pure vowel, a compound vowel, and stroke addition according to the length of the dragging gesture.
